(19) United States
(12) Patent Application Publication
(10) Pub. No.: US 2025/0141616 A1
(43) Pub. Date: May 1, 2025

(54) Distributed-Tone Resource Unit Optimization To Improve Sepctrum Mask In Wireless Communications

(71) Applicant: MediaTek Inc., Hsinchu City (TW)

(72) Inventors: Shengquan Hu, San Jose, CA (US); Jianhan Liu, San Jose, CA (US); Thomas Edward Pare, JR., San Jose, CA (US)

(21) Appl. No.: 18/928,148

(22) Filed: Oct. 27, 2024

Related U.S. Application Data
(60) Provisional application No. 63/593,544, filed on Oct. 27, 2023.

(51) Int. Cl. H04L 5/00

(52) U.S. Cl. CPC H04L 5/0048; H04L 5/0032; H04L 5/0094

(57) ABSTRACT

Techniques pertaining to distributed-tone resource unit (DRU) optimization to improve spectrum mask in wireless communications are described. An apparatus (e.g., a station (STA)) generates a DRU according to a tone plan. The apparatus also applies a first shift and a second shift to tones of the DRU in a first half of the tone plan and tones of the DRU in a second half of the tone plan, respectively. The apparatus then performs a wireless communication with the DRU.

### CROSS REFERENCE TO RELATED PATENT APPLICATION

The present disclosure is part of a non-provisional patent application claiming the priority benefit of U.S. Provisional Patent Application No. 63/593,544 filed 27 Oct. 2023, the content of which herein being incorporated by reference in its entirety.

### TECHNICAL FIELD

The present disclosure is generally related to wireless communications and, more particularly, to distributed-tone resource unit (DRU) optimization to improve spectrum mask in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) in WLAN systems in accordance with the Institute of Electrical and Electronics Engineers (IEEE) 802.11 standards, the use of DRUs can boost transmission power in 6 GHz low-power indoor (LPI) systems. Some studies show that a larger power amplifier (PA) backoff may be necessary for DRUs to meet a spectrum mask requirement. Therefore, there is a need for a solution for DRU optimization to improve spectrum mask in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to DRU optimization to improve spectrum mask in wireless communications. It is believed that implementations of various schemes proposed herein may address or otherwise alleviate the aforementioned issues. For instance, implementations of an optimized DRU tone plan under the proposed schemes may preserve more edge tones to improve the spectrum mask and reduce the PA backoff. Under the proposed schemes, the optimized DRU tone plan may be achieved by a constant shift of an original DRU tone plan. Accordingly, the optimized DRU tone plan may keep the hierarchical structure, preserve original DRU tone distribution pattern without tone overlapping, and achieve power boost gains.

In one aspect, a method may involve generating a DRU according to a tone plan. The method may also involve applying a first shift and a second shift to tones of the DRU in a first half of the tone plan and tones of the DRU in a second half of the tone plan, respectively. The method may further involve performing a wireless communication with the DRU.

In another aspect, an apparatus may include a transceiver configured to communicate wirelessly and a processor coupled to the transceiver. The processor may generate a DRU according to a tone plan. The processor may also apply a first shift and a second shift to tones of the DRU in a first half of the tone plan and tones of the DRU in a second half of the tone plan, respectively. The processor may further perform a wireless communication with the DRU.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of an example design under a proposed scheme in accordance with the present disclosure.

FIG. 8 is a diagram of an example design under a proposed scheme in accordance with the present disclosure.

FIG. 9 is a diagram of an example design under a proposed scheme in accordance with the present disclosure.

FIG. 10 is a diagram of an example design under a proposed scheme in accordance with the present disclosure.

FIG. 11 is a diagram of an example design under a proposed scheme in accordance with the present disclosure.

FIG. 12 is a diagram of an example design under a proposed scheme in accordance with the present disclosure.

FIG. 13 is a diagram of an example design under a proposed scheme in accordance with the present disclosure.

FIG. 14 is a diagram of an example design under a proposed scheme in accordance with the present disclosure.

FIG. 15 is a diagram of an example design under a proposed scheme in accordance with the present disclosure.

FIG. 16 is a diagram of an example design under a proposed scheme in accordance with the present disclosure.

FIG. 17 is a diagram of an example design under a proposed scheme in accordance with the present disclosure.

FIG. 18 is a diagram of an example design under a proposed scheme in accordance with the present disclosure.

FIG. 19 is a diagram of an example design under a proposed scheme in accordance with the present disclosure.

FIG. 20 is a diagram of an example design under a proposed scheme in accordance with the present disclosure.

FIG. 21 is a diagram of an example design under a proposed scheme in accordance with the present disclosure.

FIG. 22 is a diagram of an example design under a proposed scheme in accordance with the present disclosure.

FIG. 23 is a diagram of an example design under a proposed scheme in accordance with the present disclosure.

FIG. 24 is a block diagram of an example communication system in accordance with an implementation of the present disclosure.

FIG. 25 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to DRU optimization to improve spectrum mask in wireless communications. According to the present disclosure, a number of possible solutions may be implemented separately or jointly. That is, although these possible solutions may be described below separately, two or more of these possible solutions may be implemented in one combination or another.

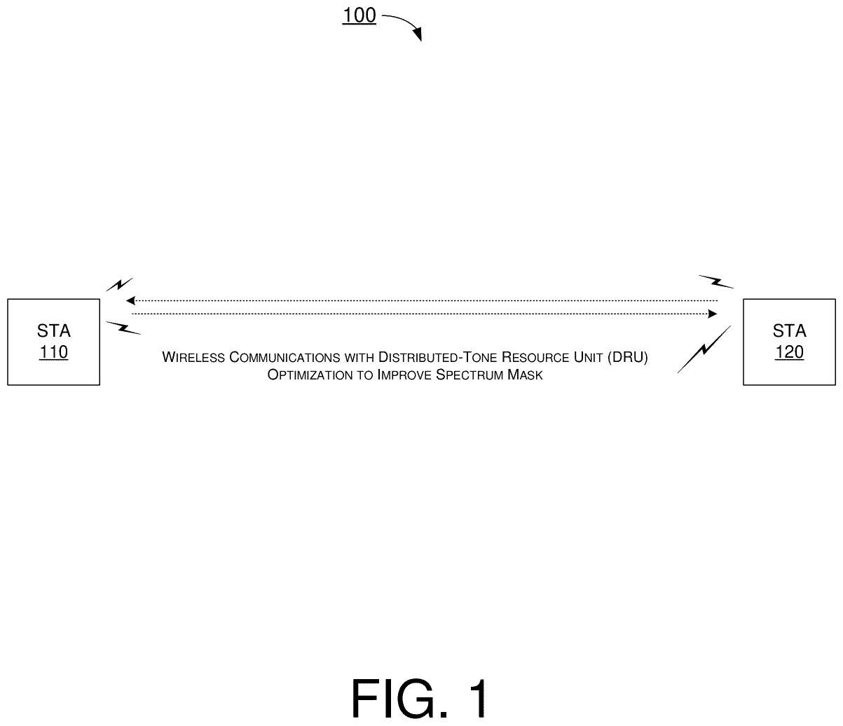

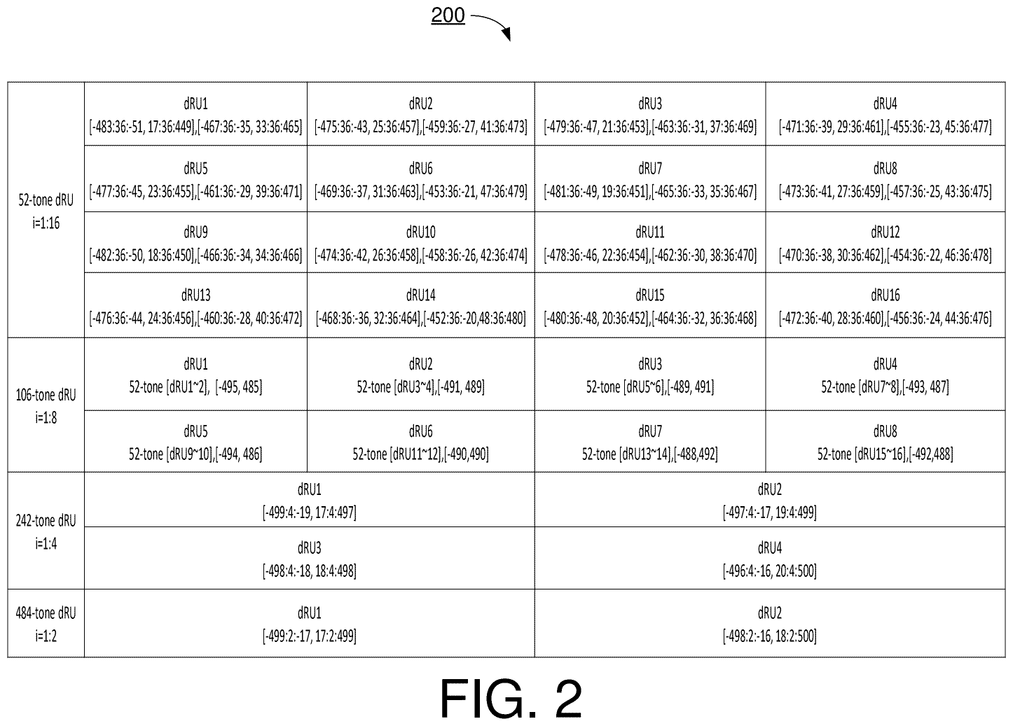

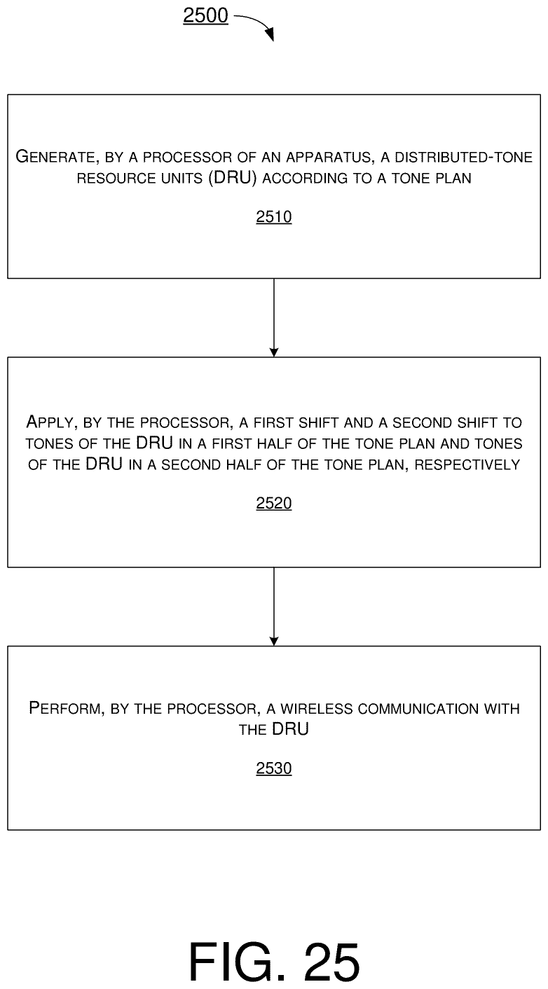

FIG. 1 illustrates an example network environment 100 in which various solutions and schemes in accordance with the present disclosure may be implemented. FIG. 2˜FIG. 25 illustrate examples of implementation of various proposed schemes in network environment 100 in accordance with the present disclosure. The following description of various proposed schemes is provided with reference to FIG. 1˜FIG. 25.

Referring to part (A) of FIG. 1, network environment 100 may involve at least a station (STA) 110 communicating wirelessly with a STA 120. Either of STA 110 and STA 120 may function as an access point (AP) STA or, alternatively, a non-AP STA. In some cases, STA 110 and STA 120 may be associated with a basic service set (BSS) in accordance with one or more IEEE 802.11 standards (e.g., IEEE 802.11bn and future-developed standards). Each of STA 110 and STA 120 may be configured to communicate with each other by utilizing the DRU optimization to improve spectrum mask in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

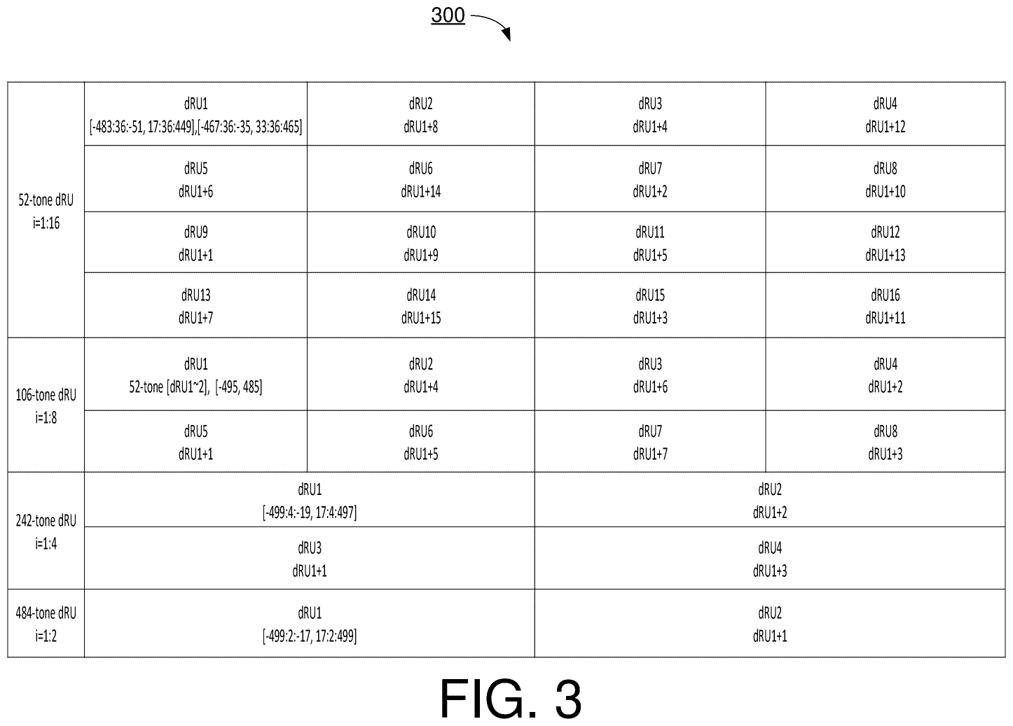

FIG. 2 illustrates an example design 200 of an 80 MHz (BW80) DRU tone plan under a proposed scheme in accordance with the present disclosure. FIG. 3 illustrates an example design 300 of a BW80 DRU tone plan under a proposed scheme in accordance with the present disclosure. Each of design 200 and design 300 may pertain to data tone plans of a 52-tone DRU, 106-tone DRU, 242-tone DRU and 484-tone DRU on an 80 MHz bandwidth or frequency segment. Referring to the table shown in each of FIG. 2 and FIG. 3, the 52-tone DRU tone plan may involve sixteen DRUs (shown as dRU1, dRU2, dRU3, . . . dRU16 in FIG. 2), the 106-tone DRU tone plan may involve eight DRUs shown as dRU1, dRU2, dRU3, . . . dRU8 in FIG. 2), the 242-tone DRU tone plan may involve four DRUs (shown as dRU1, dRU2, dRU3 and dRU4 in FIG. 2), and the 484-tone DRU tone plan may involve two DRUs (shown as dRU1 and dRU2 in FIG. 2). Referring to design 200 in FIG. 2, for the 52-tone DRU tone plan, indices of the data tones of DRU1 may be shown as [−483: 36: −51, 17: 36: 449], [−467: 36: −35, 33: 36: 465], and indices of the data tones of DRU2 may be shown as [−475: 36: −43, 25: 36: 457], [−459: 36: −27, 41: 36: 473]. As can be seen, there is a right-ward shift of eight tones from DRU1 to DRU2. Thus, referring to design 300 in FIG. 3, for the 52-tone DRU tone plan the indices of data tones of DRU2 may be represented as “dRU1+8”. The same may be said about other DRUs in the 52-tone DRU tone plan as well as the DRUs in the 106-tone, 242-tone and 484-tone DRU tone plans. In other words, design 300 may be viewed as an alternative representation of design 200.

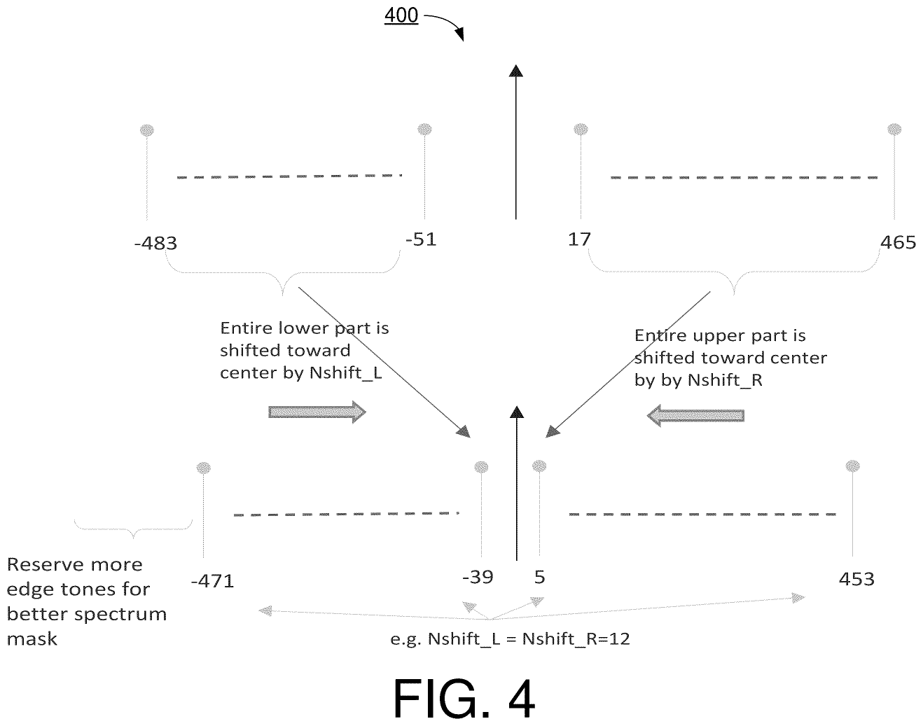

FIG. 4 illustrates an example design 400 under a proposed scheme in accordance with the present disclosure. Design 400 may pertain to DRU tone plan optimization under the proposed scheme. To preserve more edge tones to improve spectrum mask, an original DRU tone plan (e.g., the DRU tone plan shown in FIG. 2 and FIG. 3) may be optimized by performing a shift of the original DRU tone plan toward a center of the original DRU tone plan (e.g., a center direct-current (DC) tone) for both the lower part (shown on the left side in the figures, herein interchangeably referred to as a “first half” of the original DRU tone plan) and upper part (shown on the right side in the figures, herein interchangeably referred to as a “second half” of the original DRU tone plan). That is, a shift toward a center DC tone (herein denoted as “N_{shift_L}”) may be applied to the lower part of the original DRU tone plan, while a shift toward the center DC tone (herein denoted as “N_{shift_R}”) may be applied to the upper part of the original DRU tone plan. Under the proposed scheme, the value of N_{shift_L} and the value of N_{shift_R} may be the same or different. For instance, a constant shift toward the center DC tone may be applied to both the upper part and lower part of the original DRU tone plan. Accordingly, the DRU tone distribution pattern behavior may be preserved similar to that of the original DRU tone plan. Moreover, under the proposed scheme, the value of each of N_{shift_L} and N_{shift_R} may be any integer in a range from 1 to 14 or other integer values, and the value of each of N_{shift_L} and N_{shift_R} may be an even integer number or an odd integer number. As shown in FIG. 4, by shifting both the lower part (or first half) and the upper part (or second half) of the original DRU tone plan towards the center of the tone plan, more edge tones may be reserved (and not used for data or pilot tones of DRU(s)), thereby improving the spectrum mask.

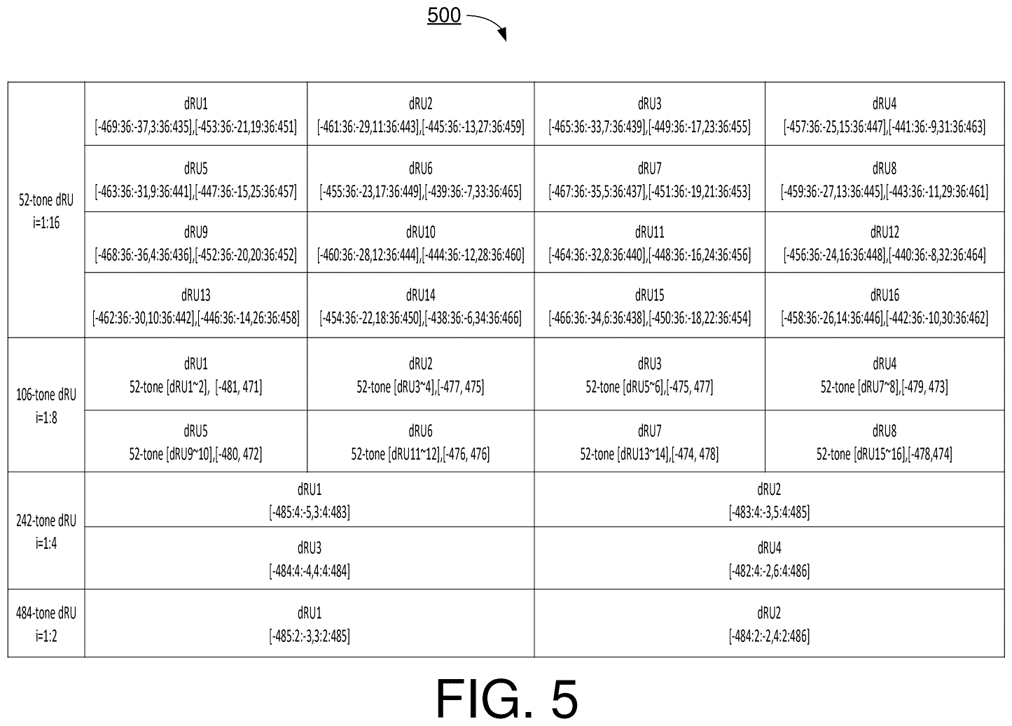

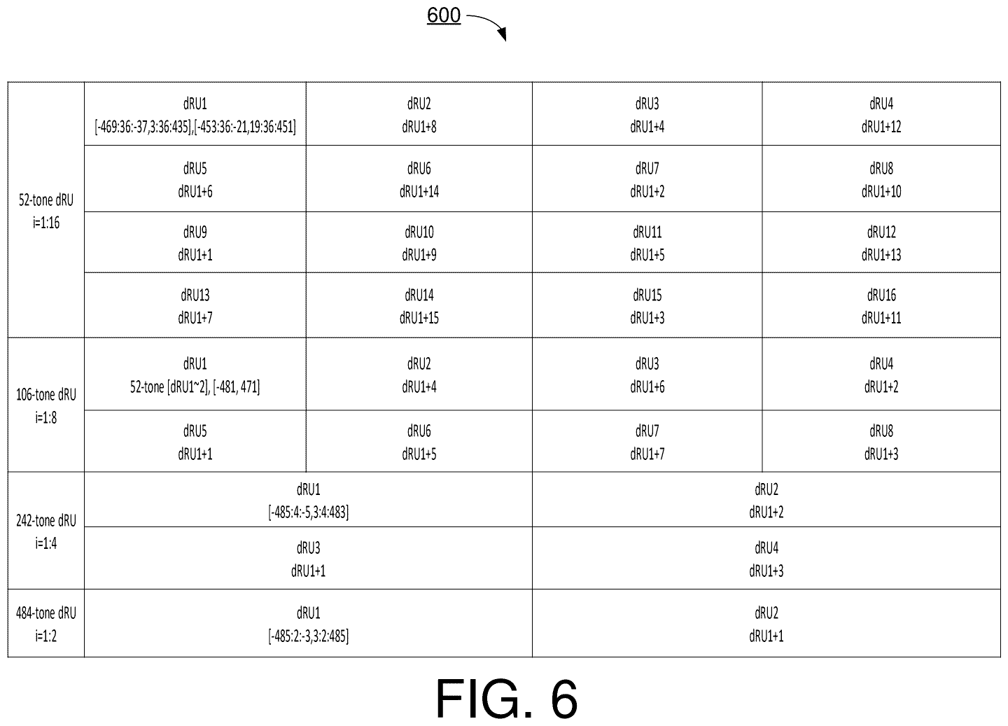

FIG. 5 illustrates an example design 500 under a proposed scheme in accordance with the present disclosure. FIG. 6 illustrates an example design 600 under a proposed scheme in accordance with the present disclosure. Each of design 500 and design 600 may pertain to a first option (Option-1) of DRU tone plan optimization under a proposed scheme, while design 600 may be viewed as an alternative representation of design 500. In design 500 and design 600, a constant shift of 14 tones toward the center may be applied to both the lower part and upper part of each of the 52-tone, 106-tone, 242-tone and 484-tone DRU tone plans.

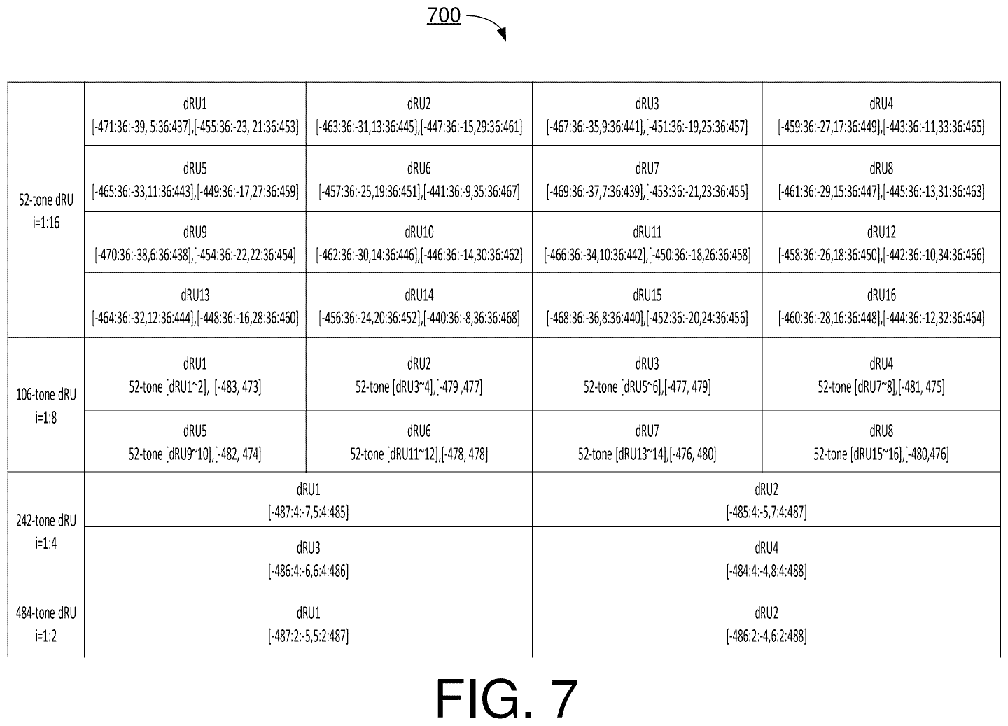

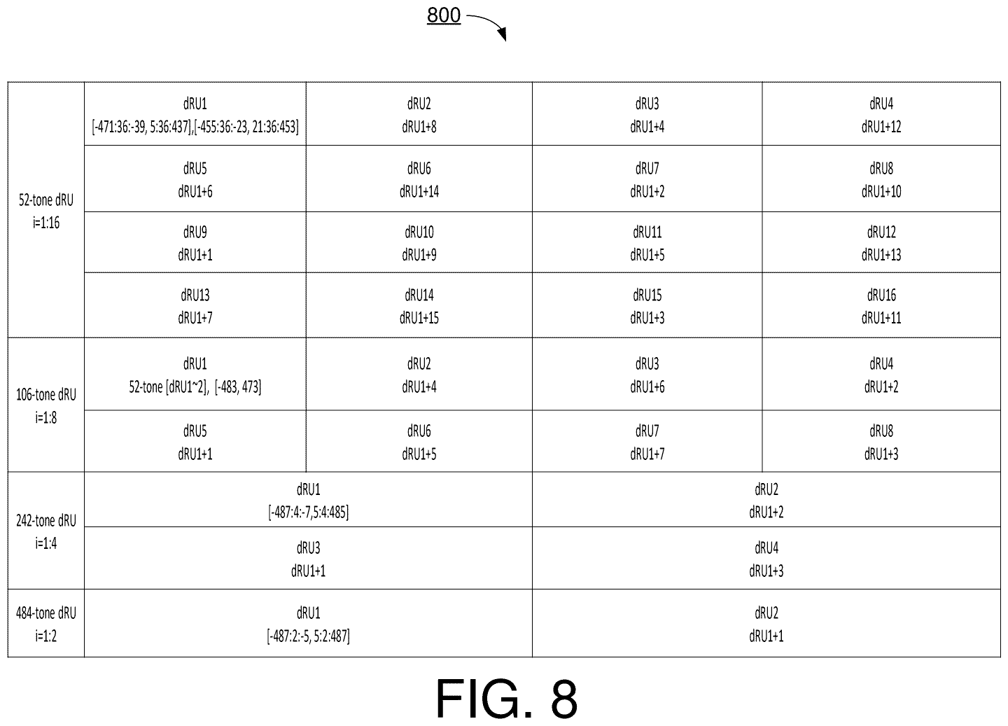

FIG. 7 illustrates an example design 700 under a proposed scheme in accordance with the present disclosure. FIG. 8 illustrates an example design 800 under a proposed scheme in accordance with the present disclosure. Each of design 700 and design 800 may pertain to a second option (Option-2) of DRU tone plan optimization under a proposed scheme, while design 800 may be viewed as an alternative representation of design 700. In design 700 and design 800, a constant shift of 12 tones toward the center may be applied to both the lower part and upper part of each of the 52-tone, 106-tone, 242-tone and 484-tone DRU tone plans.

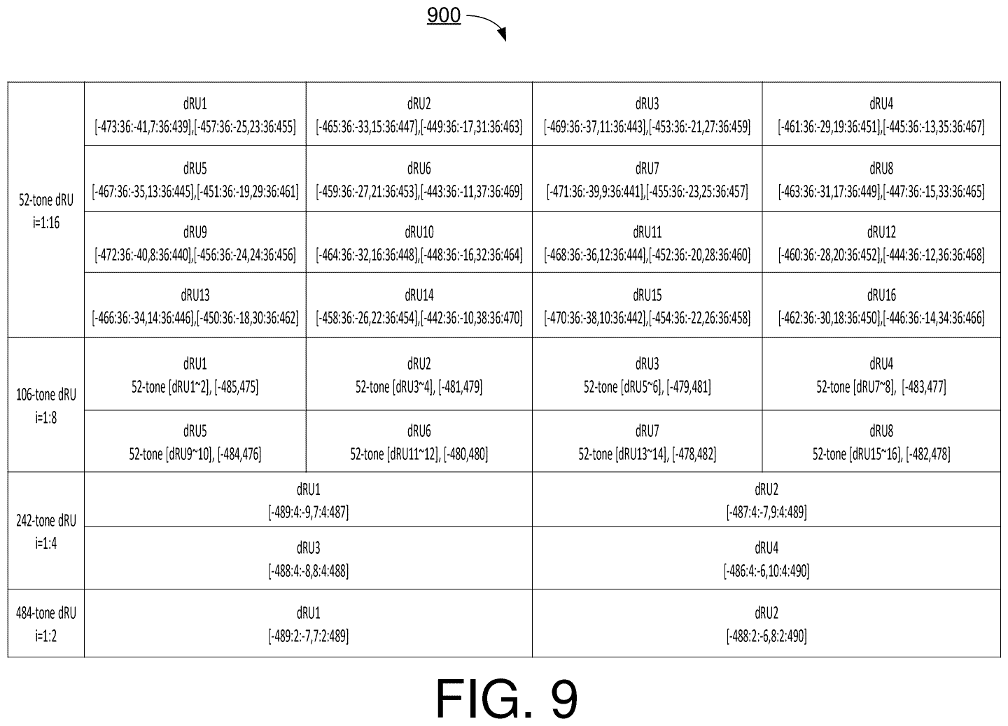

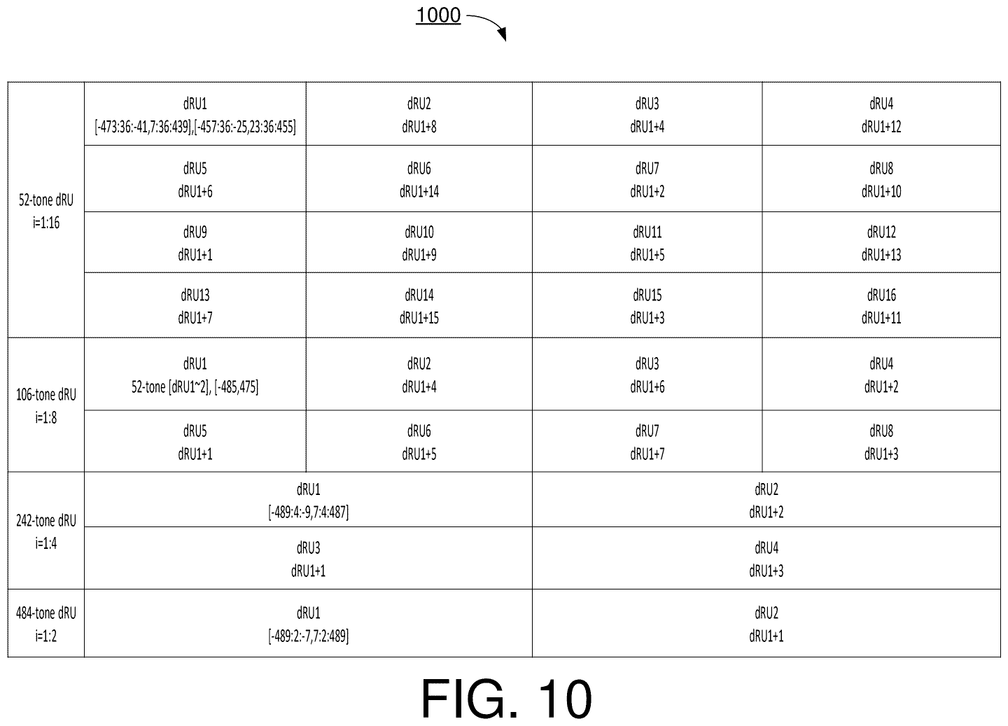

FIG. 9 illustrates an example design 900 under a proposed scheme in accordance with the present disclosure. FIG. 10 illustrates an example design 1000 under a proposed scheme in accordance with the present disclosure. Each of design 900 and design 1000 may pertain to a third option (Option-3) of DRU tone plan optimization under a proposed scheme, while design 1000 may be viewed as an alternative representation of design 900. In design 900 and design 1000, a constant shift of 10 tones toward the center may be applied to both the lower part and upper part of each of the 52-tone, 106-tone, 242-tone and 484-tone DRU tone plans.

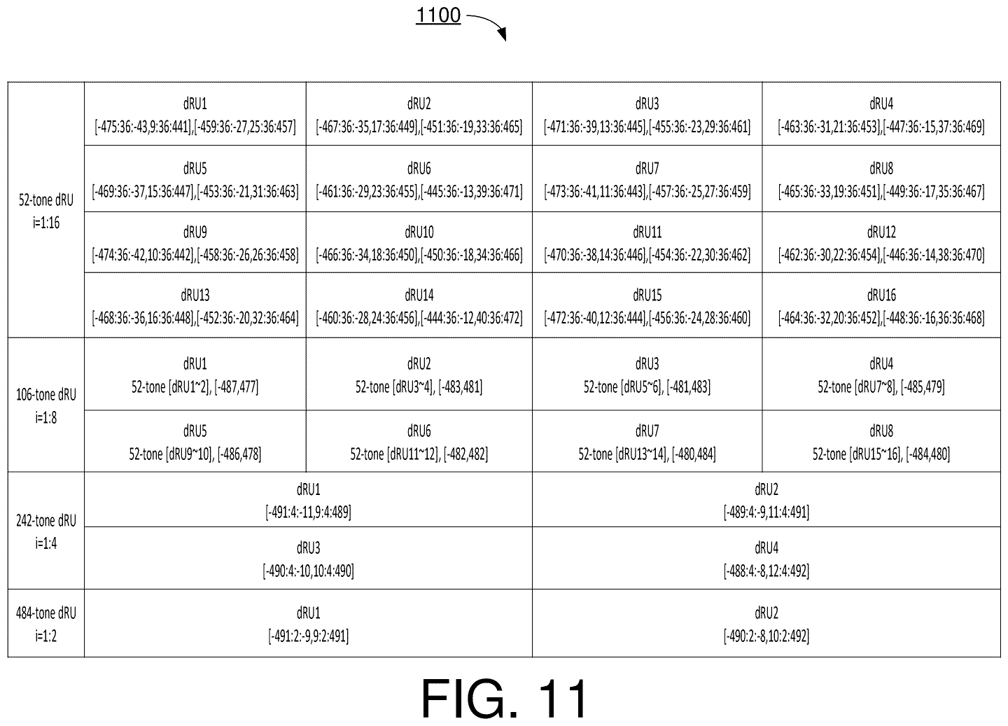

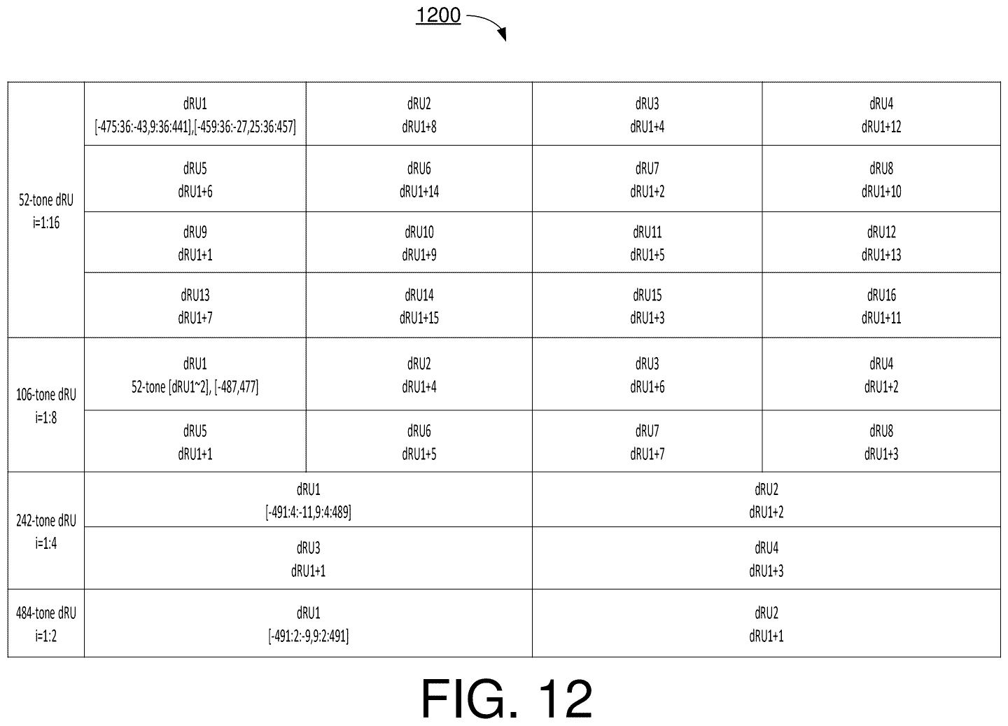

FIG. 11 illustrates an example design 1100 under a proposed scheme in accordance with the present disclosure. FIG. 12 illustrates an example design 1200 under a proposed scheme in accordance with the present disclosure. Each of design 1100 and design 1200 may pertain to a fourth option (Option-4) of DRU tone plan optimization under a proposed scheme, while design 1200 may be viewed as an alternative representation of design 1100. In design 1100 and design 1200, a constant shift of 8 tones toward the center may be applied to both the lower part and upper part of each of the 52-tone, 106-tone, 242-tone and 484-tone DRU tone plans.

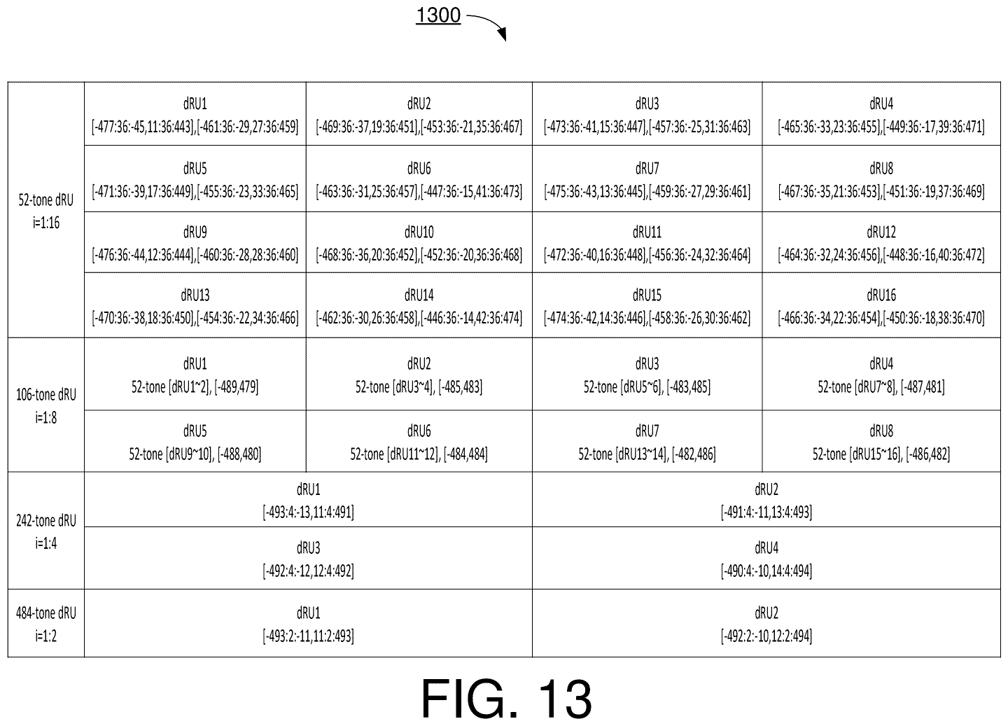

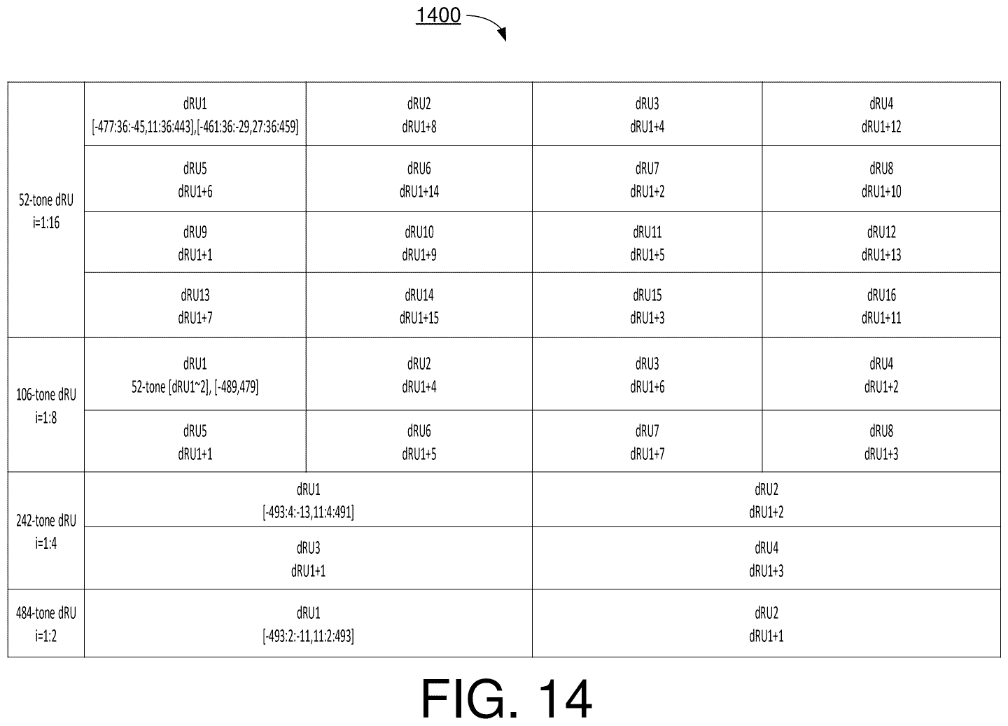

FIG. 13 illustrates an example design 1300 under a proposed scheme in accordance with the present disclosure. FIG. 14 illustrates an example design 1400 under a proposed scheme in accordance with the present disclosure. Each of design 1300 and design 1400 may pertain to a fifth option (Option-5) of DRU tone plan optimization under a proposed scheme, while design 1400 may be viewed as an alternative representation of design 1300. In design 1300 and design 1400, a constant shift of 6 tones toward the center may be applied to both the lower part and upper part of each of the 52-tone, 106-tone, 242-tone and 484-tone DRU tone plans.

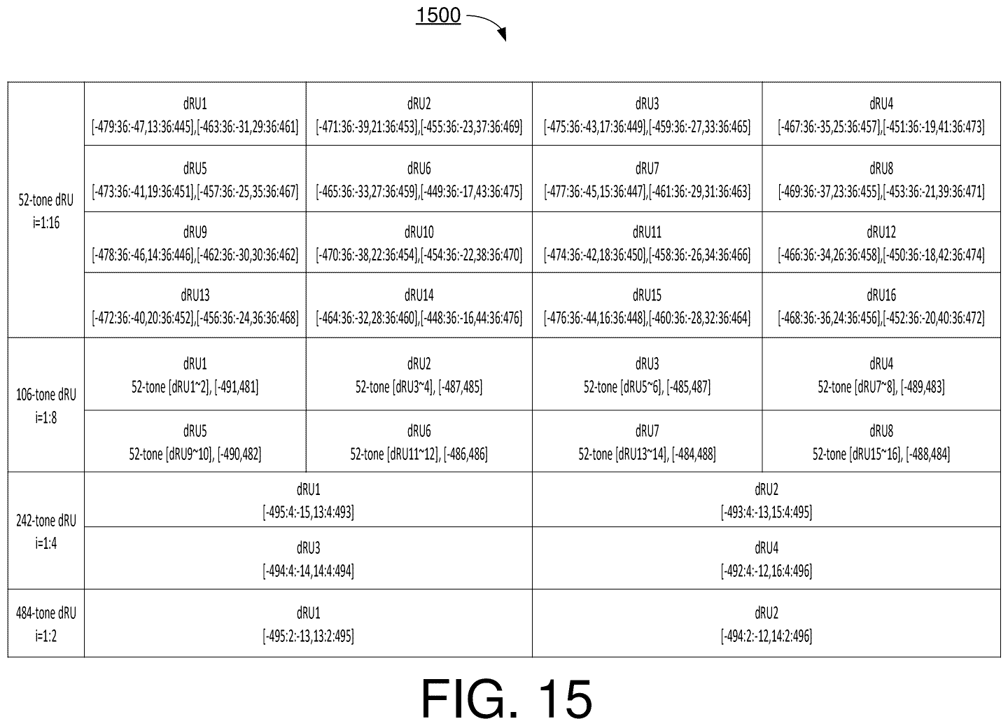

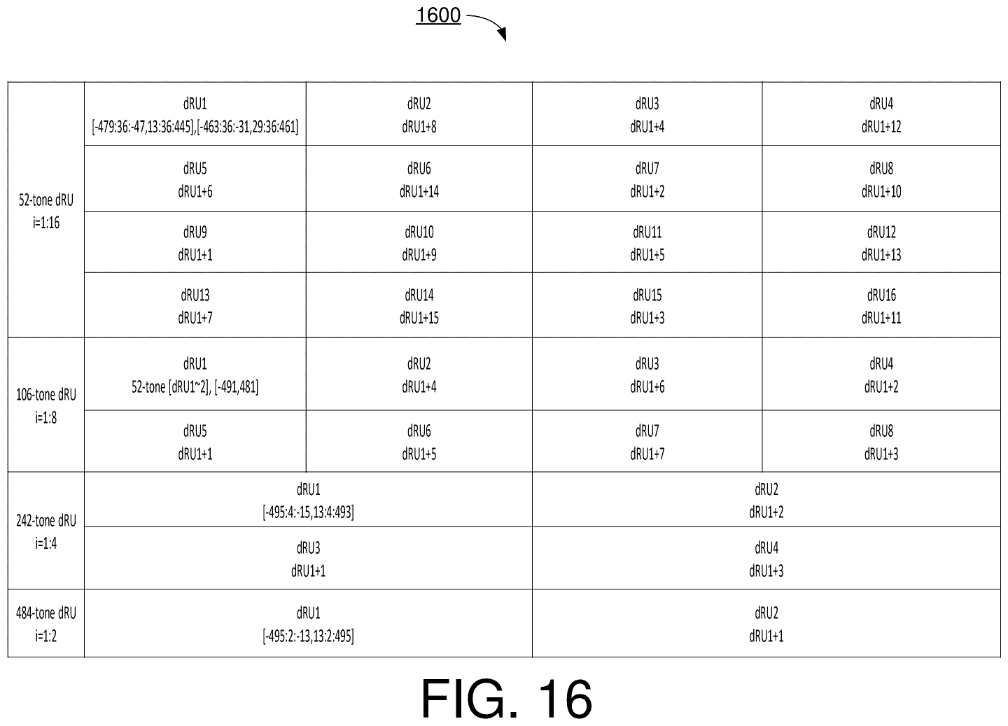

FIG. 15 illustrates an example design 1500 under a proposed scheme in accordance with the present disclosure. FIG. 16 illustrates an example design 1600 under a proposed scheme in accordance with the present disclosure. Each of design 1500 and design 1600 may pertain to a sixth option (Option-6) of DRU tone plan optimization under a proposed scheme, while design 1600 may be viewed as an alternative representation of design 1500. In design 1500 and design 1600, a constant shift of 4 tones toward the center may be applied to both the lower part and upper part of each of the 52-tone, 106-tone, 242-tone and 484-tone DRU tone plans.

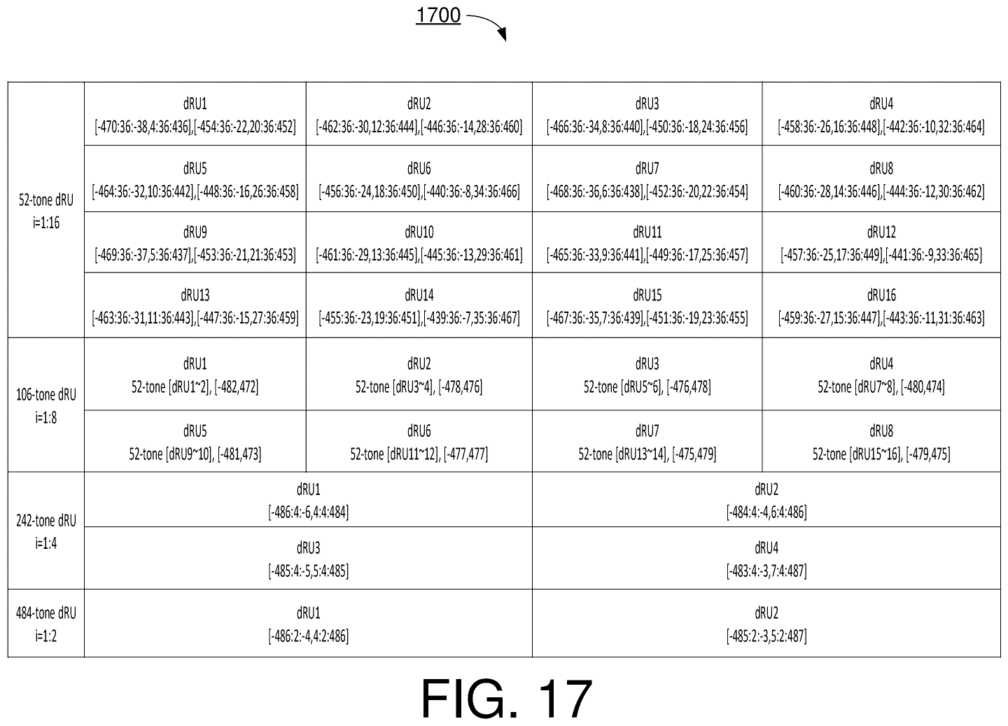

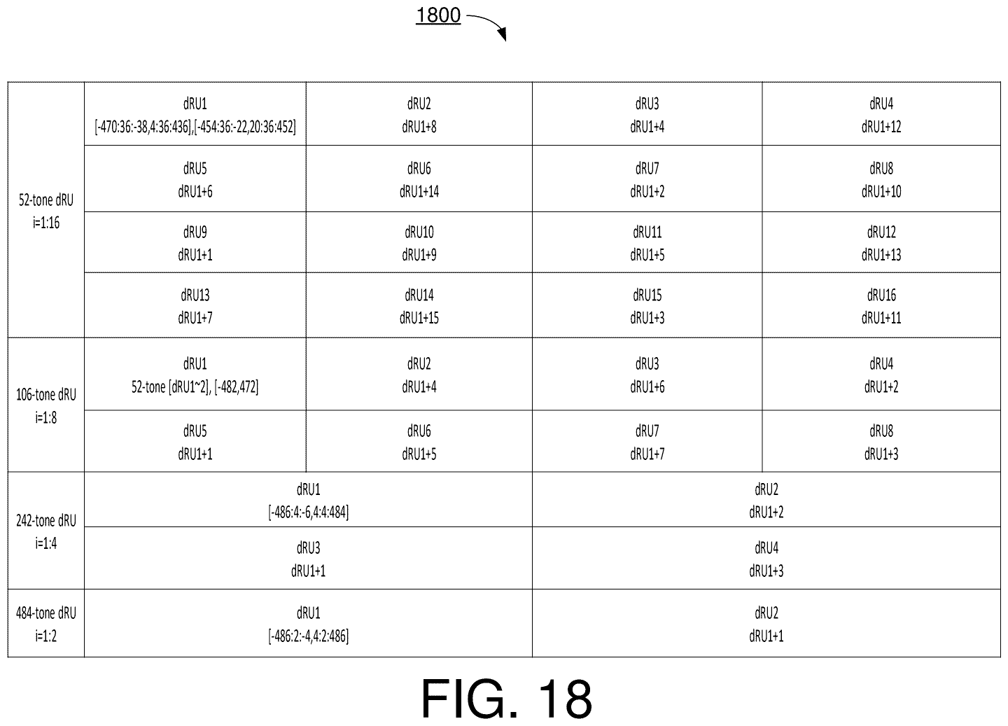

FIG. 17 illustrates an example design 1700 under a proposed scheme in accordance with the present disclosure. FIG. 18 illustrates an example design 1800 under a proposed scheme in accordance with the present disclosure. Each of design 1700 and design 1800 may pertain to a seventh option (Option-7) of DRU tone plan optimization under a proposed scheme, while design 1800 may be viewed as an alternative representation of design 1700. In design 1700 and design 1800, a constant shift of 13 tones toward the center may be applied to both the lower part and upper part of each of the 52-tone, 106-tone, 242-tone and 484-tone DRU tone plans.

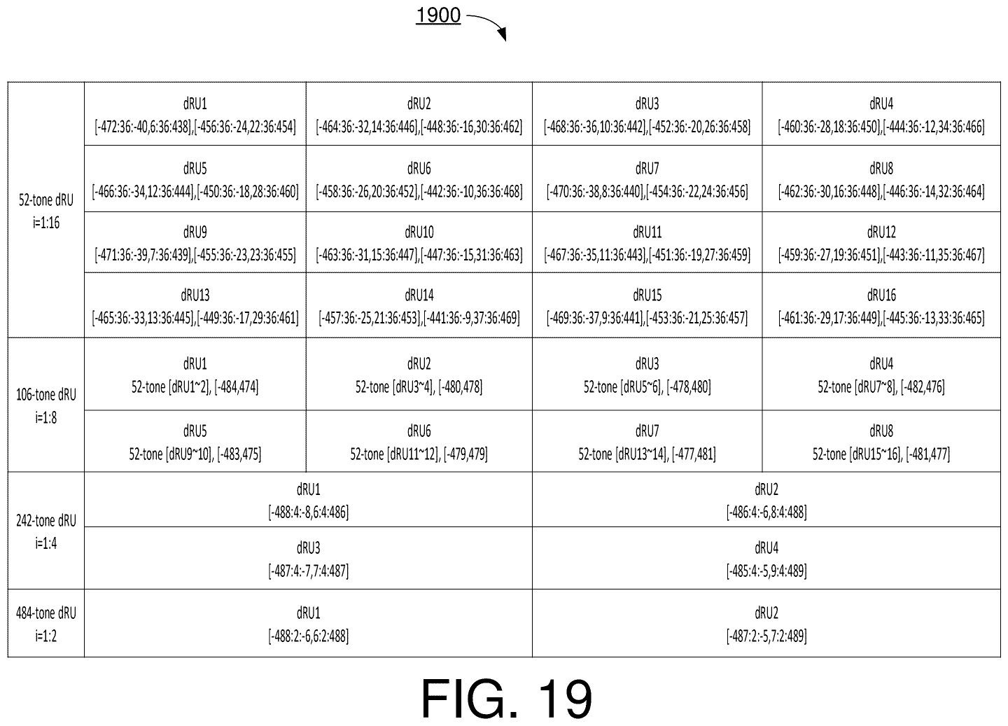

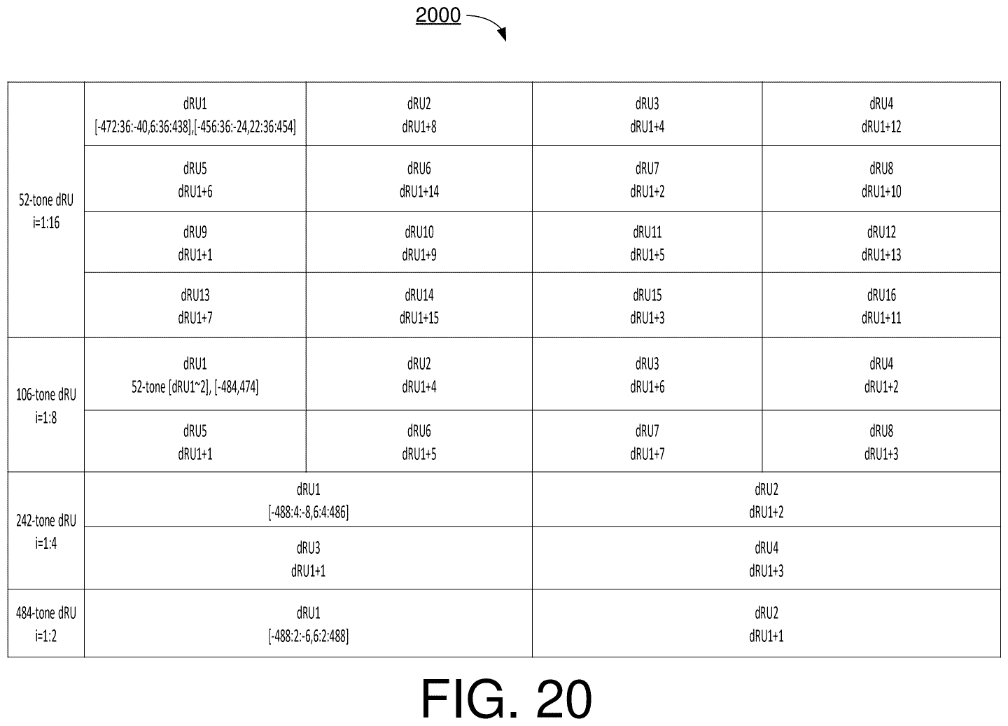

FIG. 19 illustrates an example design 1900 under a proposed scheme in accordance with the present disclosure. FIG. 20 illustrates an example design 2000 under a proposed scheme in accordance with the present disclosure. Each of design 1900 and design 2000 may pertain to an eighth option (Option-8) of DRU tone plan optimization under a proposed scheme, while design 2000 may be viewed as an alternative representation of design 1900. In design 1900 and design 2000, a constant shift of 11 tones toward the center may be applied to both the lower part and upper part of each of the 52-tone, 106-tone, 242-tone and 484-tone DRU tone plans.

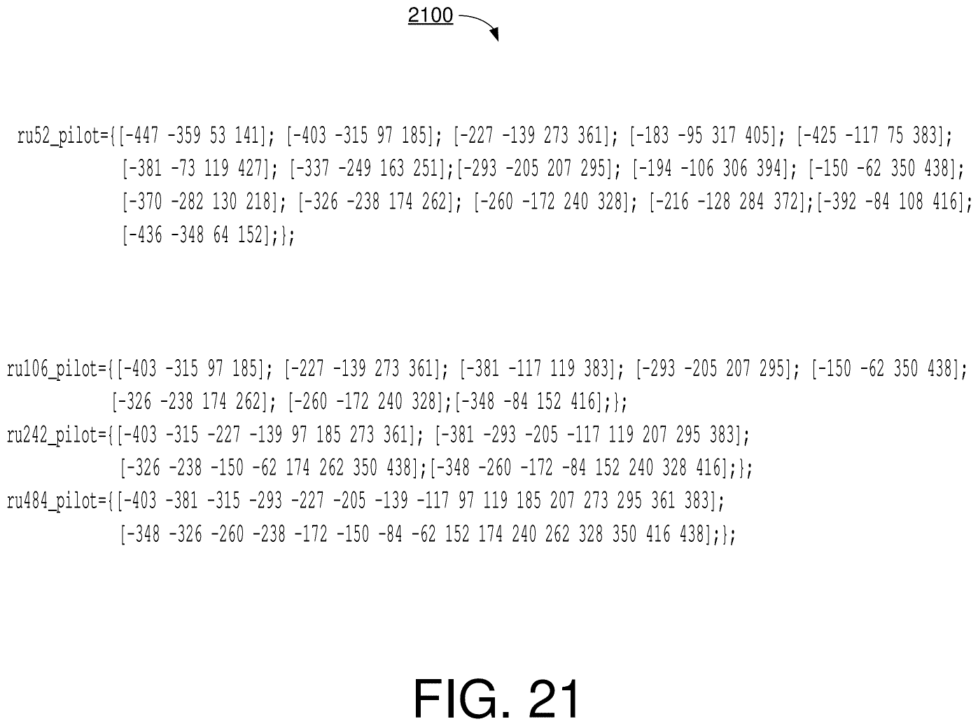

FIG. 21 illustrates an example design 2100 under a proposed scheme in accordance with the present disclosure. Design 2100 may pertain to pilot tone plans of a 52-tone DRU, 106-tone DRU, 242-tone DRU and 484-tone DRU on an 80 MHz bandwidth or frequency segment.

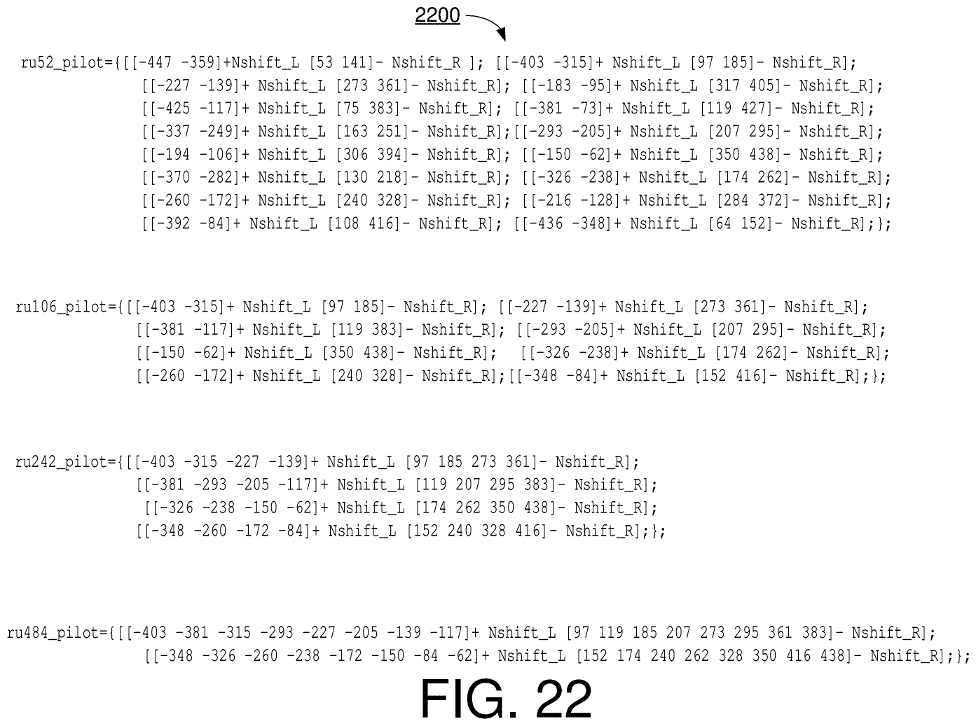

FIG. 22 illustrates an example design 2200 under a proposed scheme in accordance with the present disclosure. Design 2200 may pertain to DRU pilot tone plan optimization under the proposed scheme. Under the proposed scheme, the DRU pilot tone plan shown in FIG. 22 may be optimized by performing a shift of the original DRU pilot tone plan toward a center of the original DRU tone plan (e.g., a center DC tone) for both the lower part and upper part. That is, a shift toward a center DC tone (herein denoted as “N_{shift_L}”) may be applied to pilot tones in the lower part of the original DRU pilot tone plan, while a shift toward the center DC tone (herein denoted as “N_{shift_R}”) may be applied to pilot tones in the upper part of the original DRU pilot tone plan. Under the proposed scheme, the value of N_{shift_L} and the value of N_{shift_R} may be the same or different. For instance, a constant shift toward the center DC tone may be applied to pilot tones in both the upper part and lower part of the original DRU pilot tone plan. Under the proposed scheme, the value of each of N_{shift_L} and N_{shift_R} may be any integer in a range from 1 to 14 or other integer values, and the value of each of N_{shift_L} and N_{shift_R} may be an even integer number or an odd integer number. In the example shown in FIG. 22, an optimized DRU pilot tone plan may be generated by applying a constant shift of N_{shift_L} and N_{shift_R} to pilot tones the lower part and upper part of the original DRU pilot tone plan of FIG. 21, respectively, with N_{shift_L} and N_{shift_R} having the same value under any of Option-1˜Option-8 described above.

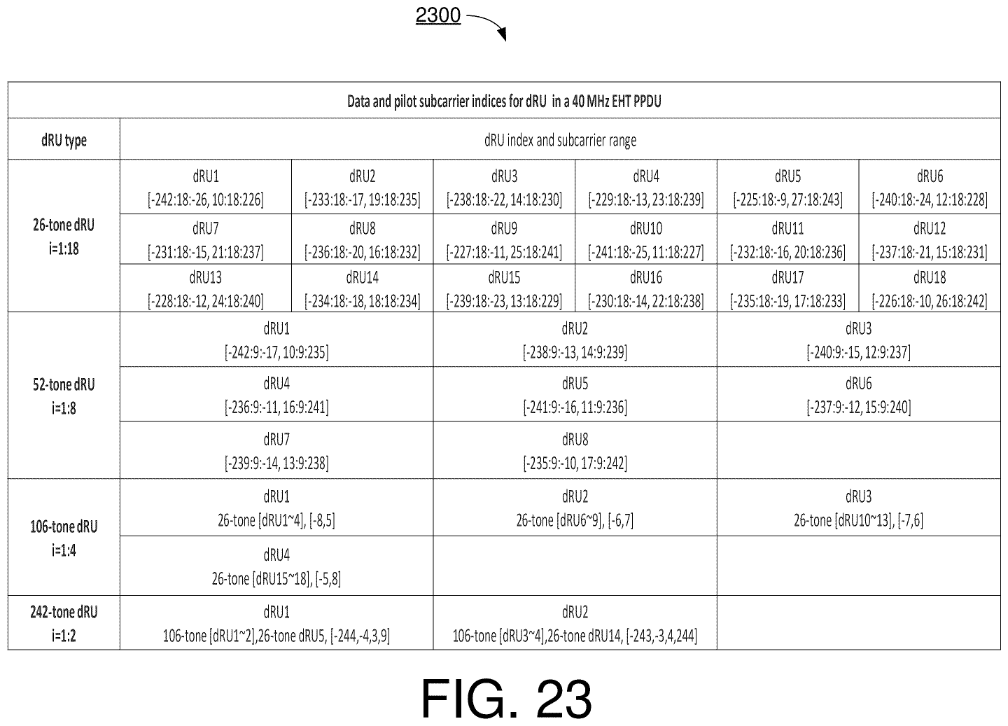

FIG. 23 illustrates an example design 2300 under a proposed scheme in accordance with the present disclosure. Design 2300 may pertain to data and pilot tone plans of a 52-tone DRU, 106-tone DRU, 242-tone DRU and 484-tone DRU on a 40 MHz (BW40) bandwidth or frequency segment. Like with an 80 MHz bandwidth or frequency segment, the data and pilot tone plans of a 52-tone DRU, 106-tone DRU, 242-tone DRU and 484-tone DRU on the 40 MHz bandwidth or frequency segment may be optimized by applying a shift to each of the lower part and upper part of the original data and pilot tone plan under the various proposed schemes in accordance with the present disclosure (e.g., under any of Option-1˜Option-8 described above).

### Illustrative Implementations

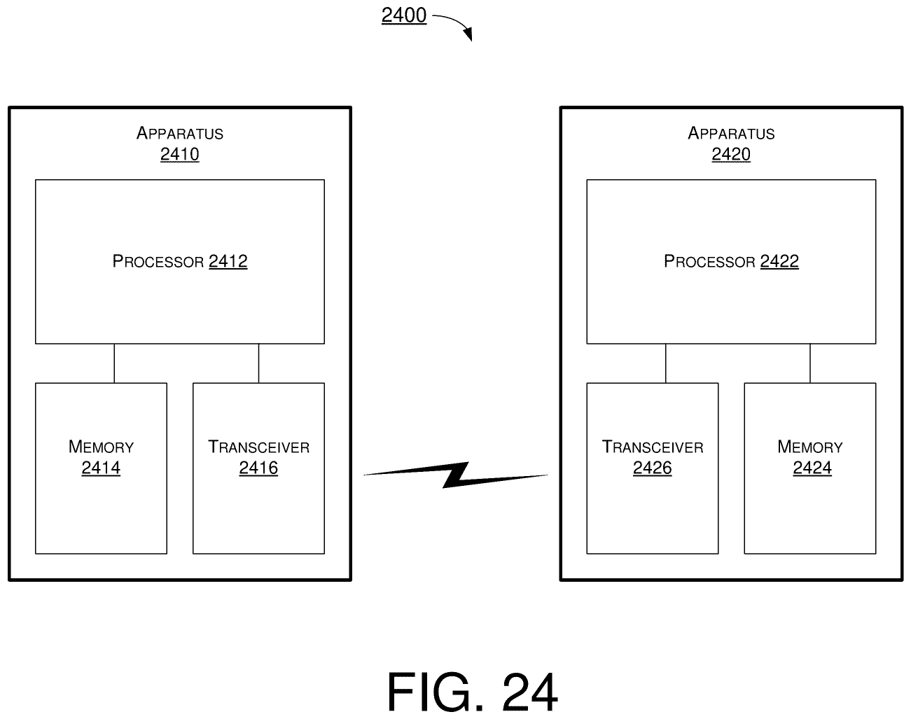

FIG. 24 illustrates an example system 2400 having at least an example apparatus 2410 and an example apparatus 2420 in accordance with an implementation of the present disclosure. Each of apparatus 2410 and apparatus 2420 may perform various functions to implement schemes, techniques, processes and methods described herein pertaining to DRU optimization to improve spectrum mask in wireless communications including the various schemes described above with respect to various proposed designs, concepts, schemes, systems and methods described above as well as processes described below. For instance, apparatus 2410 may be implemented in STA 110 and apparatus 2420 may be implemented in STA 120, or vice versa.

Each of apparatus 2410 and apparatus 2420 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 2410 and apparatus 2420 may be implemented in a smartphone, a smart watch, a personal digital assistant, a digital camera, or a computing equipment such as a tablet computer, a laptop computer or a notebook computer. Each of apparatus 2410 and apparatus 2420 may also be a part of a machine type apparatus, which may be an IoT apparatus such as an immobile or a stationary apparatus, a home apparatus, a wire communication apparatus or a computing apparatus. For instance, each of apparatus 2410 and apparatus 2420 may be implemented in a smart thermostat, a smart fridge, a smart door lock, a wireless speaker or a home control center. When implemented in or as a network apparatus, apparatus 2410 and/or apparatus 2420 may be implemented in a network node, such as an AP in a WLAN.

In some implementations, each of apparatus 2410 and apparatus 2420 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 2410 and apparatus 2420 may be implemented in or as a STA or an AP. Each of apparatus 2410 and apparatus 2420 may include at least some of those components shown in FIG. 24 such as a processor 2412 and a processor 2422, respectively, for example. Each of apparatus 2410 and apparatus 2420 may further include one or more other components not pertinent to the proposed scheme of the present disclosure (e.g., internal power supply, display device and/or user interface device), and, thus, such component(s) of apparatus 2410 and apparatus 2420 are neither shown in FIG. 24 nor described below in the interest of simplicity and brevity.

In one aspect, each of processor 2412 and processor 2422 may be implemented in the form of one or more single-core processors, one or more multi-core processors, one or more RISC processors or one or more CISC processors. That is, even though a singular term “a processor” is used herein to refer to processor 2412 and processor 2422, each of processor 2412 and processor 2422 may include multiple processors in some implementations and a single processor in other implementations in accordance with the present disclosure. In another aspect, each of processor 2412 and processor 2422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 2412 and processor 2422 is a special-purpose machine specifically designed, arranged and configured to perform specific tasks including those pertaining to DRU optimization to improve spectrum mask in wireless communications in accordance with various implementations of the present disclosure.

In some implementations, apparatus 2410 may also include a transceiver 2416 coupled to processor 2412. Transceiver 2416 may include a transmitter capable of wirelessly transmitting and a receiver capable of wirelessly receiving data. In some implementations, apparatus 2420 may also include a transceiver 2426 coupled to processor 2422. Transceiver 2426 may include a transmitter capable of wirelessly transmitting and a receiver capable of wirelessly receiving data. It is noteworthy that, although transceiver 2416 and transceiver 2426 are illustrated as being external to and separate from processor 2412 and processor 2422, respectively, in some implementations, transceiver 2416 may be an integral part of processor 2412 as a system on chip (SoC), and transceiver 2426 may be an integral part of processor 2422 as a SoC.

In some implementations, apparatus 2410 may further include a memory 2414 coupled to processor 2412 and capable of being accessed by processor 2412 and storing data therein. In some implementations, apparatus 2420 may further include a memory 2424 coupled to processor 2422 and capable of being accessed by processor 2422 and storing data therein. Each of memory 2414 and memory 2424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 2414 and memory 2424 may include a type of read-only memory (ROM) such as mask ROM, programmable ROM (PROM), erasable programmable ROM (EPROM) and/or electrically erasable programmable ROM (EEPROM). Alternatively, or additionally, each of memory 2414 and memory 2424 may include a type of non-volatile random-access memory (NVRAM) such as flash memory, solid-state memory, ferroelectric RAM (FeRAM), magnetoresistive RAM (MRAM) and/or phase-change memory.

Each of apparatus 2410 and apparatus 2420 may be a communication entity capable of communicating with each other using various proposed schemes in accordance with the present disclosure. For illustrative purposes and without limitation, a description of capabilities of apparatus 2410, as STA 110, and apparatus 2420, as STA 120, is provided below in the context of example process 2500. It is noteworthy that, although a detailed description of capabilities, functionalities and/or technical features of apparatus 2420 is provided below, the same may be applied to apparatus 2410 although a detailed description thereof is not provided solely in the interest of brevity. It is also noteworthy that, although the example implementations described below are provided in the context of WLAN, the same may be implemented in other types of networks.

### Illustrative Processes

FIG. 25 illustrates an example process 2500 in accordance with an implementation of the present disclosure. Process 2500 may represent an aspect of implementing various proposed designs, concepts, schemes, systems and methods described above. More specifically, process 2500 may represent an aspect of the proposed concepts and schemes pertaining to DRU optimization to improve spectrum mask in wireless communications in accordance with the present disclosure. Process 2500 may include one or more operations, actions, or functions as illustrated by one or more of blocks 2510, 2520 and 2530. Although illustrated as discrete blocks, various blocks of process 2500 may be divided into additional blocks, combined into fewer blocks, or eliminated, depending on the desired implementation. Moreover, the blocks/sub-blocks of process 2500 may be executed in the order shown in FIG. 25 or, alternatively, in a different order. Furthermore, one or more of the blocks/sub-blocks of process 2500 may be executed repeatedly or iteratively. Process 2500 may be implemented by or in apparatus 2410 and apparatus 2420 as well as any variations thereof. Solely for illustrative purposes and without limiting the scope, process 2500 is described below in the context of apparatus 2410 implemented in or as STA 110 functioning as a non-AP STA or an AP STA and apparatus 2420 implemented in or as STA 120 functioning as an AP STA or a non-AP STA of a wireless network such as a WLAN in network environment 100 in accordance with one or more of IEEE 802.11 standards. Process 2500 may begin at block 2510.

At 2510, process 2500 may involve processor 2412 of apparatus 2410 generating a DRU according to a tone plan. Process 2500 may proceed from 2510 to 2520.

At 2520, process 2500 may involve processor 2412 applying a first shift and a second shift to tones of the DRU in a first half of the tone plan and tones of the DRU in a second half of the tone plan, respectively. Process 2500 may proceed from 2520 to 2530.

At 2530, process 2500 may involve processor 2412 performing, via transceiver 2416, a wireless communication with the DRU (e.g., transmitting the DRU to apparatus 2420).

In some implementations, in applying the first shift and the second shift, process 2500 may involve processor 2412 applying a constant shift toward a center of the tone plan to each of the first half and the second half of the tone plan such that data tones of the DRU in the first half shift toward the center and data tones of the DRU in the second half shift toward the center by a same number of tones (e.g., N_{shift_L}=N_{shift_R}).

In some implementations, a value of the constant shift may include an even integer. Alternatively, the value of the constant shift may include an odd integer.

In some implementations, the value of the constant shift may be 14, 12, 10, 8, 6 or 4. Alternatively, the value of the constant shift may be 13 or 11.

In some implementations, in applying the first shift and the second shift, process 2500 may involve processor 2412 applying the first shift toward a center of the tone plan to the first half and applying the second shift toward the center of the tone plan to the second half of the tone plan, with the first shift and the second shift being different, such that the tones of the DRU in the first half shift toward the center and the tones of the DRU in the second half shift toward the center by different numbers of tones (e.g., N_{shift_L}≠N_{shift_R}).

In some implementations, in applying the first shift and the second shift, process 2500 may involve processor 2412 applying the first shift toward a center of the tone plan to pilot tones of the first half and applying the second shift toward the center of the tone plan to pilot tones of the second half of the tone plan, and wherein the first shift and the second shift comprise a constant shift.

In some implementations, in generating the DRU, process 2500 may involve processor 2412 generating a 52-tone DRU, a 106-tone DRU, a 242-tone DRU or a 484-tone DRU.

In some implementations, in performing the wireless communication with the DRU, process 2500 may involve processor 2412 transmitting the DRU over a 40 MHz or 80 MHz bandwidth or frequency segment.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a distributed-tone resource units (DRU) according to a tone plan;
applying, by the processor, a first shift and a second shift to tones of the DRU in a first half of the tone plan and tones of the DRU in a second half of the tone plan, respectively; and
performing, by the processor, a wireless communication with the DRU.

2. The method of claim 1, wherein the applying of the first shift and the second shift comprises applying a constant shift toward a center of the tone plan to each of the first half and the second half of the tone plan such that the tones of the DRU in the first half shift toward the center and the tones of the DRU in the second half shift toward the center by a same number of tones.

3. The method of claim 2, wherein a value of the constant shift comprises an even integer.

4. The method of claim 3, wherein the value of the constant shift comprises 14, 12, 10, 8, 6 or 4.

5. The method of claim 2, wherein a value of the constant shift comprises an odd integer.

6. The method of claim 5, wherein the value of the constant shift comprises 13 or 11.

7. The method of claim 1, wherein the applying of the first shift and the second shift comprises applying the first shift toward a center of the tone plan to the first half and applying the second shift toward the center of the tone plan to the second half of the tone plan, with the first shift and the second shift being different, such that the tones of the DRU in the first half shift toward the center and the tones of the DRU in the second half shift toward the center by different numbers of tones.

8. The method of claim 1, wherein the applying of the first shift and the second shift comprises applying the first shift toward a center of the tone plan to pilot tones of the first half and applying the second shift toward the center of the tone plan to pilot tones of the second half of the tone plan, and wherein the first shift and the second shift comprise a constant shift.

9. The method of claim 1, wherein the generating of the DRU comprises generating a 52-tone DRU, a 106-tone DRU, a 242-tone DRU or a 484-tone DRU.

10. The method of claim 1, wherein the performing of the wireless communication with the DRU comprises transmitting the DRU over a 40 MHz or 80 MHz bandwidth or frequency segment.

11. An apparatus, comprising:
a transceiver configured to communicate wirelessly; and
a processor coupled to the transceiver and configured to perform operations comprising:
generating a distributed-tone resource units (DRU) according to a tone plan;
applying a first shift and a second shift to tones of the DRU in a first half of the tone plan and tones of the DRU in a second half of the tone plan, respectively; and
performing, via the transceiver, a wireless communication with the DRU.

12. The apparatus of claim 11, wherein the applying of the first shift and the second shift comprises applying a constant shift toward a center of the tone plan to each of the first half and the second half of the tone plan such that the tones of the DRU in the first half shift toward the center and the tones of the DRU in the second half shift toward the center by a same number of tones.

13. The apparatus of claim 12, wherein a value of the constant shift comprises an even integer.

14. The apparatus of claim 13, wherein the value of the constant shift comprises 14, 12, 10, 8, 6 or 4.

15. The apparatus of claim 12, wherein a value of the constant shift comprises an odd integer.

16. The apparatus of claim 15, wherein the value of the constant shift comprises 13 or 11.

17. The apparatus of claim 11, wherein the applying of the first shift and the second shift comprises applying the first shift toward a center of the tone plan to the first half and applying the second shift toward the center of the tone plan to the second half of the tone plan, with the first shift and the second shift being different, such that the tones of the DRU in the first half shift toward the center and the tones of the DRU in the second half shift toward the center by different numbers of tones.

18. The apparatus of claim 11, wherein the applying of the first shift and the second shift comprises applying the first shift toward a center of the tone plan to pilot tones of the first half and applying the second shift toward the center of the tone plan to pilot tones of the second half of the tone plan, and wherein the first shift and the second shift comprise a constant shift.

19. The apparatus of claim 11, wherein the generating of the DRU comprises generating a 52-tone DRU, a 106-tone DRU, a 242-tone DRU or a 484-tone DRU.

20. The apparatus of claim 11, wherein the performing of the wireless communication with the DRU comprises transmitting the DRU over a 40 MHz or 80 MHz bandwidth or frequency segment.
